(19) United States
(12) Patent Application Publication
(10) Pub. No.: US 2025/0037411 A1
(43) Pub. Date: Jan. 30, 2025

(54) SYSTEMS AND METHODS FOR MULTI-GRANULARITY BASED SEMANTIC SEGMENTATION

(71) Applicant: Technology Innovation Institute- Sole Proprietorship LLC, Masdar City (AE)

(72) Inventors: Kebin WU, Masdar City (AE); Ameera BAWAZIR, Masdar City (AE); Xiaofei XIAO, Masdar City (AE); Ebtesam ALMAZROUEI, Masdar City (AE)

(73) Assignee: Technology Innovation Institute - Sole Proprietorship LLC, Masdar City (AE)

(21) Appl. No.: 18/779,766

(22) Filed: Jul. 22, 2024

Related U.S. Application Data
(60) Provisional application No. 63/584,623, filed on Sep. 22, 2023.
(60) Provisional application No. 63/516,370, filed on Jul. 28, 2023.

(51) Int. Cl. G06V 10/26; G06V 10/72; G06V 10/774; G06V 10/776; G06V 10/82

(52) U.S. Cl. CPC G06V 10/26; G06V 10/72; G06V 10/774; G06V 10/776; G06V 10/82; G06V 2201/03

(57) ABSTRACT

Systems, methods and computer readable storage mediums are provided. Data comprising raw images and their corresponding pixel-level semantic labels can be obtained. The data can be preprocessed to remove noisy samples or to augment the data with the technique of data augmentation. The data can be split into training and validation sets. A model and loss functions can be designed so first and second level semantic information is leveraged to boost first-level semantic segmentation. The model can comprise main and auxiliary branches. The first level semantic information can be utilized in the main branch and the second level semantic information can be utilized by the auxiliary branch. The model can be trained by the training set to iteratively minimize the loss functions. Model parameters can be updated as the loss function is minimized. The auxiliary branch can be removed after the model is trained. Results can be predicted using the trained model on samples in the validation set. Predicting results can be configured to generate pixel-level semantic segmentation labels.

### CROSS-REFERENCE TO RELATED APPLICATIONS AND INCORPORATION BY REFERENCE

This application claims benefit under 35 U.S.C. § 119 (e) of U.S. Provisional Patent Application No. 63/516,370 filed Jul. 28, 2023 and U.S. Provisional Patent Application No. 63/584,623 filed Sep. 22, 2023, which are both incorporated by reference herein in their entireties.

### BACKGROUND

### Field of the Invention

The present disclosure generally relates to systems and methods of semantic segmentation.

### Background

Semantic segmentation is a process of identifying a label or category for every pixel in an image through machine learning. It is used to recognize a collection of pixels that form distinct categories. For example, in autonomous driving applications, semantic categories could include people, sky, navigable terrain, and non-navigable terrain.

Most of the current semantic segmentation models are based on fully convolutional neural networks (FCN), which replace the fully connected layer in the classification model with convolutional layers, leading to end-to-end dense representation modeling. To overcome the limited visual context weakness of FCNs, numerous efforts have been made to effectively capture contextual information and cross-pixel relationships. Some successful attempts are enhancing receptive fields, designing global and pyramid pooling, introducing attention modules, and borrowing encoder-decoder architectures.

Recently, transformer-based methods, which are built upon the full attention architecture, have led to more impressive performance despite the high computational cost. Among them, DeepLabV3+ and PSPNet are two of the most popular segmentation models that are frequently used as baselines for supervised semantic segmentation and as benchmarks for tasks like semi-supervised semantic segmentation and domain adaptation.

Recent research suggests that coarse level segmentation, which defines its semantic classes primarily based on traversability, is sufficient for many autonomous driving applications. For instance, distinguishing trees and buildings as different categories may be unnecessary. Instead, it is reasonable to recognize both as non-navigable. Currently, only a few works validate their tasks using coarse level segmentation.

### SUMMARY

Accordingly, it is desirable to improve systems and methods of semantic segmentation that provide coarse-grained segmentation results.

Some embodiments comprise a system comprising an image sensor and an image processor. The image sensor can be configured to capture image data. The image processor can be configured to perform semantic segmentation using first level and second level semantic information, output a semantically segmented image based on the semantic segmentation, and determine whether or not to perform an action based on the semantically segmented image.

Some embodiments comprise a method including one or more of the following operations. Obtaining a set of data comprising raw images and their corresponding pixel-level semantic labels. Preprocessing the set of data to remove invalid or noisy samples. Splitting the set of data into a training set and a validation set. Designing a model and corresponding loss functions such that a first level and a second level of semantic information are leveraged substantially and simultaneously to boost first-level semantic segmentation, the model comprising a main branch and an auxiliary branch, the first level semantic information being utilized in the main branch and the second level semantic information being utilized by the auxiliary branch. Training the model by utilizing the training set to iteratively minimize the loss functions, wherein model parameters are updated as the loss function is minimized. Predicting results using the trained model on samples in the validation set. The auxiliary branch in the trained model can be removed in prediction. And the predicting results can be configured to generate pixel-level semantic segmentation labels. Some embodiments may comprise computer-readable storage medium containing program instructions for a method being executed by an application. The application may comprise code for one or more components that are called by the application during runtime. Execution of the program instructions by one or more processors of a computer system causes the one or more processors to perform one or more operations similar to the method described above.

Further features and exemplary aspects of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the embodiments and, together with the description, further serve to explain the principles of the embodiments and to enable a person skilled in the relevant art(s) to make and use the embodiments.

FIG. 1 illustrates a system for semantic segmentation, according to some embodiments.

FIG. 2 illustrates a segmentation model, according to some embodiments.

FIG. 3 illustrates a method of semantic segmentation by multiple granularity learning, according to some embodiments.

FIG. 4 illustrates a semantic segmentation method by adopting supervised multiple granularity learning, according to some embodiments.

FIG. 5 illustrates a semantic segmentation method by adopting unsupervised multiple granularity learning, according to some embodiments.

FIG. 6 illustrates a semantic segmentation result, according to some embodiments.

FIG. 7 illustrates a visualization of an embedding space for a baseline model, a model trained by supervised multiple granularity learning, and a model trained by unsupervised multiple granularity learning, according to some embodiments.

FIG. 8 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

The aspects described herein, and references in the specification to “one aspect,” “an aspect,” “an exemplary aspect,” “an example aspect,” etc., indicate that the aspects described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of those skilled in the art to effect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The terms “about,” “approximately,” or the like can be used herein to indicate the value of a given quantity that can vary based on a particular technology. Based on the particular technology, the terms “about,” “approximately,” or the like can indicate a value of a given quantity that varies within, for example, 10-30% of the value (e.g., +10%, +20%, or +30% of the value).

Aspects of the present disclosure can be implemented in hardware, firmware, software, or any combination thereof. Aspects of the disclosure can also be implemented as instructions stored on a computer-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Furthermore, firmware, software, routines, and/or instructions can be described herein as performing certain actions. However, it should be appreciated that such descriptions are merely for convenience and that such actions result from computing devices, processors, controllers, or other devices executing the firmware, software, routines, instructions, etc. The term “machine-readable medium” can be interchangeable with similar terms, for example, “computer program product,” “computer-readable medium,” “non-transitory computer-readable medium,” or the like. The term “non-transitory” can be used herein to characterize one or more forms of computer readable media except for a transitory, propagating signal.

In some embodiments, a system of semantic segmentation can include an image capture device, an image processing device and an action unit. The image capture device can provide a raw image to the image processing device, which can further comprise a raw data handling unit and a segmentation unit. The raw data handling unit may remove noise and/or resize the image before transferring the image to the segmentation unit. The segmentation unit may implement a semantic segmentation model. In some embodiments, an action unit can use a segmentation result to determine an appropriate action.

In some embodiments, the semantic segmentation model may be trained through a multiple granularity learning framework.

In some embodiments, the segmentation unit can be configured to provide coarse-grained labels. The segmentation unit can generate a segmentation result, which is provided to the action unit.

In some embodiments, a coarse-grained semantic segmentation model may comprise a feature extractor and a segmentation head. A feature extractor may comprise a convolutional neural network, or the like. A segmentation head may comprise a segmentation framework, such as PSPNet or DeepLabV3+. In some embodiments, a coarse-grained semantic segmentation model may be trained using a multiple granularity learning framework.

In some embodiments, the action unit may determine an action to take based on the segmentation result. In some embodiments, an action unit may determine a direction of travel for an autonomous vehicle.

In some embodiments, a multiple granularity learning framework can utilize fine-grained labels in a multi-branch architecture to generate coarse-grained segmentation results. In some embodiments, when fine-grained labels are unavailable, a pretext task may be implemented through self-supervised learning in a multi-branch architecture to improve coarse-grained semantic segmentation.

In some embodiments, semantic segmentation by multiple granularity learning can improve coarse-grained semantic segmentation models by incorporating fine-grained semantic segmentation labels in a multi-branch architecture. A multi-branch architecture can allow a model to learn a more distinctive representation space, thereby optimizing coarse-grained segmentation. Additionally, learning with multiple granularities (fine and coarse) can allow the system to mitigate overfitting, that can make a model more robust.

In some embodiments, a multiple granularity learning frameworks may be implemented by adding an auxiliary branch to a main branch during model training. The main branch may comprise a feature extractor and a segmentation head and utilize coarse-labeled training data. Like the main branch, the auxiliary branch may also comprise a feature extractor and a segmentation head. The feature extractor in the two branches may share parameters. The auxiliary branch may utilize fine-grained training labels. During training, a traditional cross entropy loss may be adopted for the main branch, and a focal loss may be adopted for the auxiliary branch. The combined loss function may comprise a weighted average of the loss on the main branch and the loss on the auxiliary branch. Semantic knowledge learned by the auxiliary branch can benefit the main branch since the feature extractors in the two branches may share parameters. After training, the auxiliary branch may be removed in the inference stage.

When fine-grained labels are unavailable, a pretext task may be implemented in an auxiliary branch to improve coarse-grained semantic segmentation. Even when fine-grained subclasses are unlabeled, subclasses can be separable in the feature space of models trained on the superclass (coarse-grained). Self-supervised learning can be used to learn representations by creating pretext tasks based on prior knowledge. A fine-grained pretext task may assume that segmentation should be invariant to local color distortions and local spatial translations. A pretext task may encourage a same pixel under different color distortions to be similar in a representation space, and push a smoothness of a representation over spatially close pixels.

In some embodiments, a multiple granularity learning framework may be implemented by training a main branch using supervised learning with coarse-labeled images and by training an auxiliary branch using a self-supervised learning task. The main branch may comprise a feature extractor and a segmentation head. The auxiliary branch may comprise a feature extractor, a first segmentation head and a second segmentation head. In some embodiments, the feature extractor of the main branch and the auxiliary branch may share parameters. In some embodiments, the first and second segmentation heads of the auxiliary branch may share parameters. To implement the pretext assumption, an input image may be color distorted to form a color distorted image.

In some embodiments, the input image can be used during training in the main branch.

Traditional cross entropy loss may be adopted for the main branch.

In some embodiments, both the input image and the color distorted image may be used during training in the auxiliary branch.

In some embodiments, the first segmentation head of the auxiliary branch can process the input image while the second segmentation head of the auxiliary branch can process the color distorted image.

In some embodiments, loss in the auxiliary branch can be calculated by minimizing the minus mutual information between results generated by the first segmentation head and results generated by the second segmentation head. The combined loss function can comprises a weighted average of the loss on the main branch and the loss on the auxiliary branch. Semantic knowledge learned by the auxiliary branch can benefit the main branch since the feature extractors in the two branches may share parameters. After training, the auxiliary branch can be removed in the inference stage.

### Exemplary Semantic Segmentation System

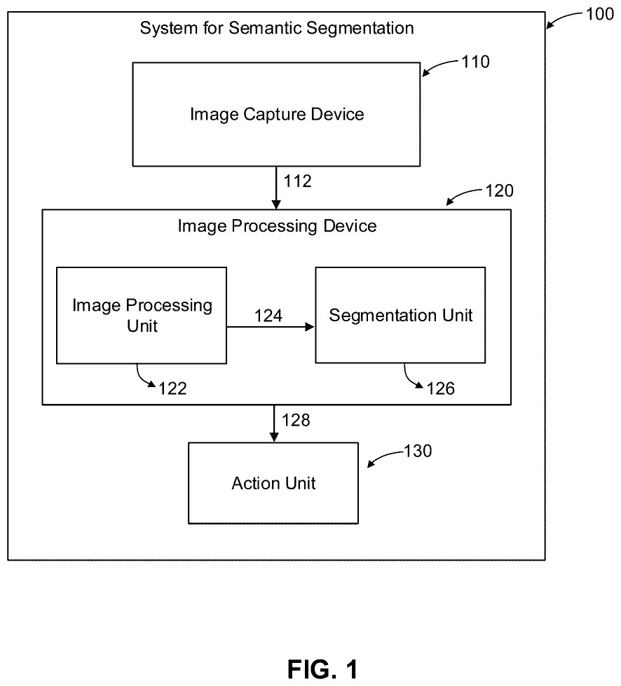

FIG. 1 shows a system 100, according to some embodiments. For example, system 100 can be a semantic segmentation system. In some aspects, system 100 can comprise an image capture device 110, an image processing device 120, and an action unit 130.

In some embodiments, image capture device 110 can be configured to capture an image of the surroundings. For example, image capture device 110 may comprise a camera, a red-greed-blue (RGB) camera, or the like. In some aspects, image capture device 110 can be configured to capture an image of an object inside a human or animal body. For example, image capture device 110 may comprise a MRI device or a CT scanner.

In some embodiments, image capture device 110 supplies a raw image 112 to image processing device 120.

In some embodiments, imaging processing device 120 can comprise raw data handling unit 122 and segmentation unit 126. In some aspects, raw data handling unit 122 may resize an image or remove noise from an image.

In some embodiments, segmentation unit 126 is configured to receive a processed image 124 from raw data handling unit 122. In some aspects, segmentation unit 126 may be configured to incorporate a multiple granularity learning framework.

In some embodiments, segmentation unit 126 may apply a method of semantic segmentation to processed image 124 to generate a segmentation result 128. In some aspects, segmentation result 128 comprises pixel level segmentation labels of processed image 124. Segmentation labels may indicate whether or not terrain is navigable. Segmentation labels may indicate whether or not disease is present in a medical image.

In some embodiments, segmentation result 128 may be provided to action unit 130. In some aspects, action unit 130 may zoom in on a region of interest in segmentation result 128. Action unit 130 may determine an action to be taken based on the semantic label of a subset of pixels in segmentation result 128. For example, action unit 130 may determine a direction of travel for an autonomous vehicle.

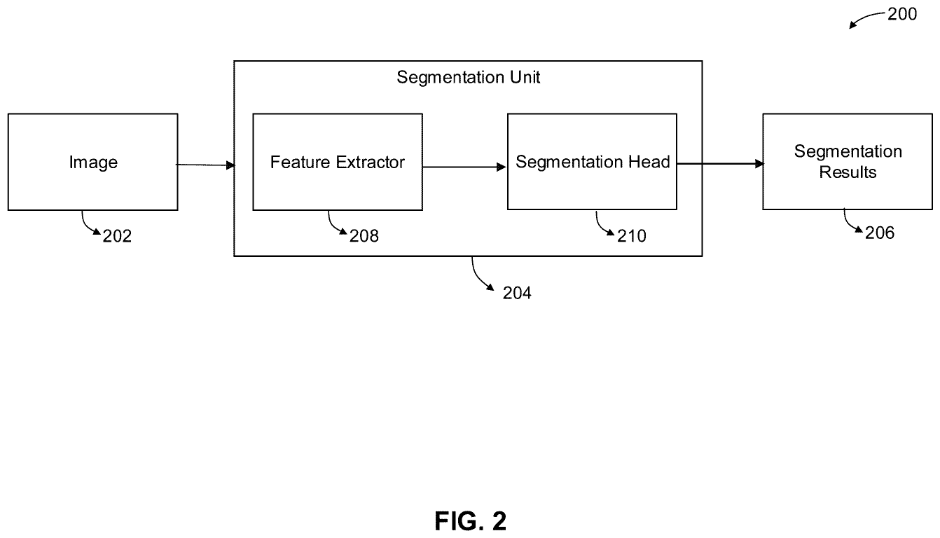

FIG. 2 shows a segmentation model 200 according to some embodiments. Segmentation model 200 may comprise an image 202, a segmentation unit 204 and segmentation results 206. Segmentation unit 204 can further comprise feature extractor 208 and segmentation head 210. In some aspects, segmentation model 200 may have been trained using a multi-granular learning framework.

In some embodiments, image 202 may be processed by feature extractor 208 and segmentation head 210 to generate segmentation result 206.

In some aspects, feature extractor 208 may comprise a convolutional neural network. For example, the convolutional neural network may comprise MobileNetV2 or ResNet-50.

In some aspects, segmentation head 210 comprises a segmentation network. For example, the segmentation network may comprise PSPNet or DeepLabV3+.

### Exemplary Method of Semantic Segmentation

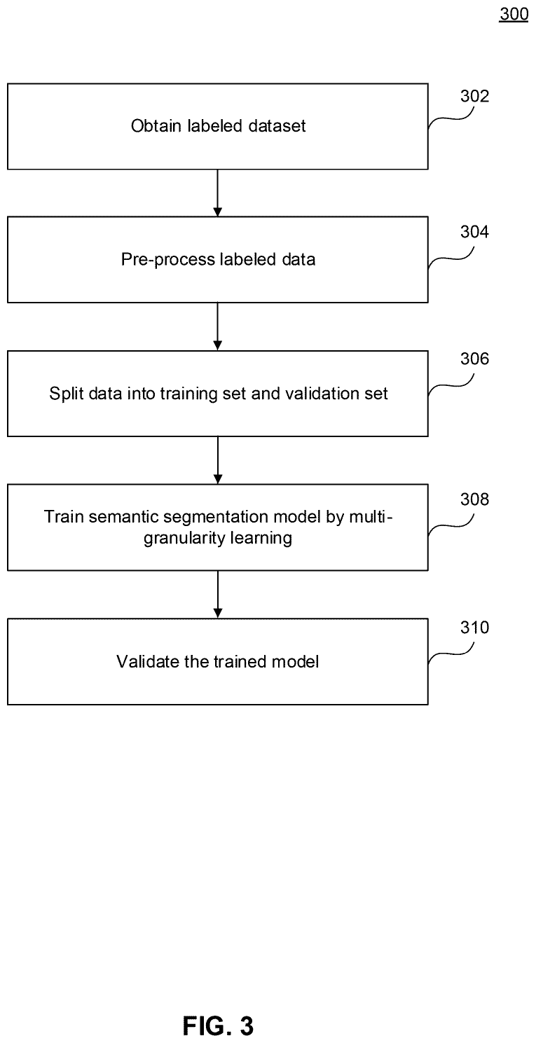

In FIG. 3, a method 300 is shown, according to some embodiments. For example, method 300 can be used to generate a semantic segmentation unit for a system. It is to be appreciated that method 300 may not perform operations in the order shown, and that some operations may not be performed based on a given application.

In step 302, a labeled data set may be obtained. In some aspects, a labeled data set may assign a fine-grained class to each object (e.g., tree and building). Fine-grained classes may be grouped into coarse-grained classes according to their traversability, or other parameters. For example, for an RGB image Iϵ [symbol] , fine-grained labels may be defined as Y_{F}∈{0,1}^{G}^{_{f}}^{*H*W} and coarse-grained labels may be defined as Y_{C}∈{0,1}^{G}^{_{c}}^{*H*w}. Here H and W are the height and width of the input image, G_{c} is the number of coarse-grained classes, and G_{f} is the number of fine-grained classes.

In some aspects, the labeled dataset may be a publicly available data set. In some aspects, the labeled dataset is a data set that is captured by a sensor and manually annotated.

In step 304, the labeled data set may be pre-processed. In some aspects, preprocessing may include removing noisy or invalid samples.

In step 306, the labeled data set may be split into a training data set and a validation data set.

In step 308, a semantic segmentation model may be trained using data from the training data set. In some embodiments, a model may be trained through multiple granularity learning. In some embodiments, a semantic segmentation model used in training may comprise a main branch and an auxiliary branch.

In some embodiments, the training data may be processed by a semantic segmentation model to generate a segmentation result. A loss function may be calculated by determining the difference between the segmentation result and a labeled image from the training data set. In some aspects, the loss function may be used to update parameters of the model through backpropagation.

In some aspects, an auxiliary branch is removed from the semantic segmentation model after training.

In step 310, images in the validation data set may be used to test the trained model. In some aspects, the segmentation results given by the trained model using the validation data set are compared to corresponding ground-truth segmentation results in the validation data set.

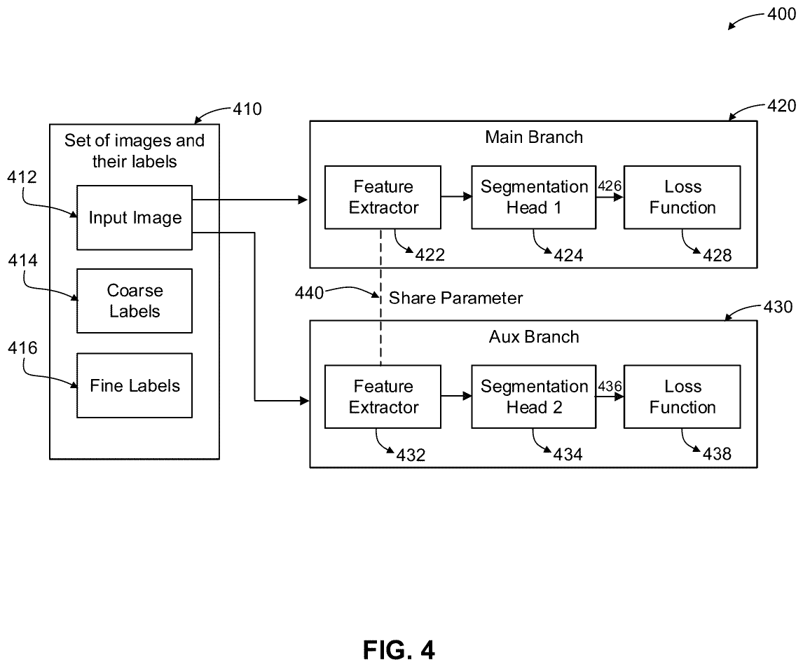

FIG. 4 shows a model training framework 400, according to some embodiments. For example, model training framework 400 may be for semantic segmentation using a multi-granularity learning framework, according to some embodiments. Model training framework 400 may be used when a data set with fine-grained labels is available. For example, model training framework 400 can be an embodiment of the semantic segmentation model used in training step 308.

In some aspects, model training framework 400 may comprise a image data set 410, a branch 420 (e.g., a main branch) and a branch 430 (e.g., an auxiliary branch). In some embodiments, branch 420 provides coarse-grained semantic segmentation labels and branch 430 provides fine-grained semantic segmentation labels. In some embodiments, coarse-grained semantic knowledge from branch 420 and fine-grained semantic knowledge from branch 430 are combined through parameter sharing 440.

In some embodiments, labeled data set 410 comprises a set of input images 412, a set of coarse-labeled images 414, and set of fine-labeled images 416. In some aspects, set of coarse-labeled images 414 and set of fine-labeled images 416 are the expected outputs of sematic segmentation models when the input of the models is set of input images 412.

In some embodiments, main branch 420 comprises a feature extractor 422, a segmentation head 424, a segmentation result 426, and a loss function 428. In some embodiments, feature extractor 422 and segmentation head 424 are configured to provide coarse-grained semantic labels.

In some embodiments, feature extractor 422 may comprise a convolutional neural network. In some embodiments, segmentation head 424 may comprise a segmentation framework, such as PSPNet or DeepLabV3+.

In some embodiments, an input image from set of input images 412 may be processed by feature extractor 422 and segmentation head 424 to generate segmentation result 426.

In some embodiments, a loss function 428 may be used to quantify a difference between segmentation result 426 and an expected segmentation result, a coarse-labeled image from set of coarse-labeled images 414.

In some embodiments, loss function 428 may be used to update parameters of feature extractor 422 and segmentation head 424 through backpropagation. In some aspects, loss function 428 may be defined as traditional cross entropy loss.

In some embodiments, auxiliary branch 430 comprises a feature extractor 432, a segmentation head 434, a segmentation result 436, and a loss function 438. In some embodiments, feature extractor 432 and segmentation head 434 are configured to provide fine-grained semantic labels. In some aspects, the feature extractor 432 from the auxiliary branch may share parameters with the feature extractor 422 in main branch.

In some embodiments, feature extractor 432 may comprise a convolutional neural network. In some embodiments, segmentation head 434 may comprise a segmentation framework, such as PSPNet or DeepLabV3+.

In some embodiments, an input image from set of input images 412 may be processed by feature extractor 432 and segmentation head 434 to generate a fine-grained segmentation result 436.

In some embodiments, loss function 438 may quantify a difference between segmentation result 436 and an expected segmentation result, a fine-labeled image from set of fine-labeled images 416.

In some embodiments, loss function 438 may be used to update parameters of feature extractor 432 and segmentation head 434 through backpropagation. In some aspects, loss function 438 may be defined as a focal loss.

In some embodiments, input image 412 is processed by both the main branch 420 and the auxiliary branch 430 simultaneously.

In some embodiments, loss function 428 and loss function 438 are weighted according to L=(1−λ)Lₘₐᵢₙ+λ Lₐᵤₓ, to form combined loss function 440. L represents combined loss function 440, Lₘₐᵢₙ is loss function 428, Lₐᵤₓ is loss function 438, and λ is the tradeoff between loss on branch 420 and loss on branch 430. In some aspects, λ may be a number in the range of 0-0.5.

In some embodiments, auxiliary branch 430 may be removed after training.

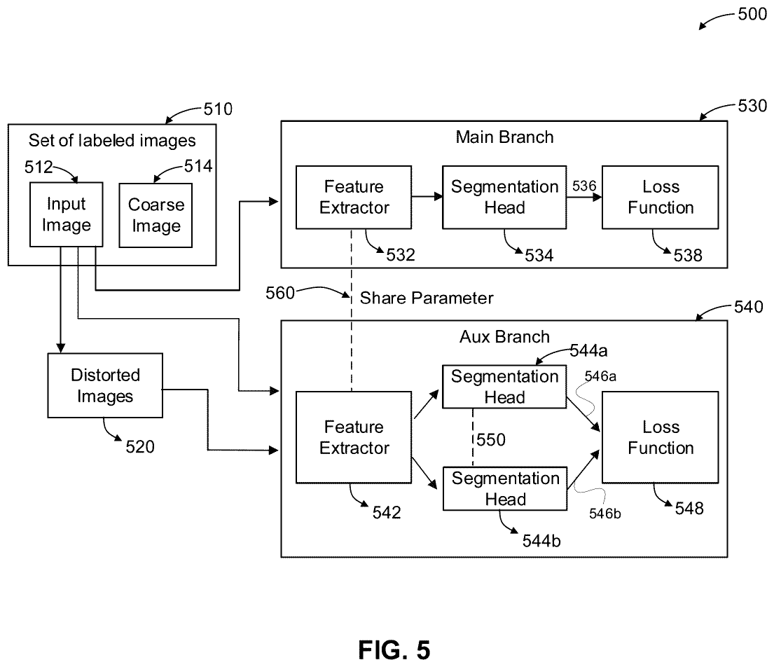

FIG. 5 illustrates a model training framework 500, according to some embodiments. For example, model training framework 500 may be for semantic segmentation by multiple granularity learning when fine-grained data labels are unavailable, according to some embodiments. For example, model training framework 500 can be a semantic segmentation model used in training step 308.

In some embodiments, fine-grained subclasses are unlabeled, but subclasses are often separable in the feature space of models trained on the superclass (coarse-grained). In some embodiments, self-supervised learning can be used to learn representations by creating pretext tasks based on prior knowledge. For example, a prediction task may assume that a learned representation should be invariant to data transformation. A prediction task may define an image and its data transformation variant as a positive pair and aim to bring them closer in an embedding space by adopting a contrastive loss.

In some embodiments, a fine-grained pretext task may assume that segmentation should be invariant to local color distortions and local spatial translations. In some embodiments, a pretext task may encourage a same pixel under different color distortions to be similar in a representation space, and to push a smoothness of a representation over spatially close pixels.

In some embodiments, model training framework 500 comprises a set of training images 510, a set of distorted images 520, a branch 530 (e.g., a main branch), and a branch 540 (e.g., auxiliary branch). In some embodiments, branch 530 and branch 540 share semantic knowledge through parameter sharing 560.

In some embodiments, set of training images 510 may comprise a set of input images 512 and a set of coarse-labeled images 514. In some aspects, set of coarse-labeled images 514 provides expected coarse-level semantic segmentation results for set of input images 512.

In some embodiments images in set of input images 512 may undergo a non-geometric augmentation transformation, such as color distortion, to form set of distorted images 520. A color distortion may randomly change the brightness, contrast, saturation, or hue of an image. In some embodiments, an input image from set of input images 512 is processed by both branch 530 and 540, while a corresponding distorted image from set of distorted images 520 is only processed by branch 540.

In some embodiments, branch 530 may comprise a feature extractor 532, a segmentation head 534, a segmentation result 536, and a loss function 538. In some aspects, feature extractor 532 may comprise a convolutional neural network and segmentation head 534 may comprise a segmentation framework, such as PSPNet or DeepLabV3+.

In some embodiments, an input image from set of input images 512 may be processed by feature extractor 532 and segmentation head 534 to generate segmentation result 536. In some aspects, segmentation result 536 comprises a coarse-grained semantically segmented image.

In some embodiments, loss function 538 calculates the difference between segmentation result 536 and an expected segmentation result, a coarse-labeled image from set of coarse-labeled images 514. In some aspects, loss function 538 may be used to update parameters of feature extractor 532 and segmentation head 534 through backpropagation.

In some embodiments, auxiliary branch 540 may implement unsupervised learning using a self-supervised pretext task.

In some embodiments, branch 540 may comprise a feature extractor 542, a segmentation head 544a, a segmentation head 544b, a segmentation result 546a, a segmentation result 546b, and a loss function 548. In some aspects, feature extractor 542 comprises a convolutional neural network. In some aspects, segmentation heads 544a and 544b may comprise a segmentation framework, such as PSPNet or DeepLabV3+.

In some embodiments, an input image from set of input images 512 and a corresponding distorted image of set of distorted images 520 are processed by feature extractor 542. Segmentation head 544a can be configured to further process the input image to generate a segmentation result 546a. Segmentation head 544b can be configured to further process the corresponding distorted image to generate a segmentation result 546b.

In some embodiments, segmentation head 544a and 544b share parameters through parameter sharing 550.

In some embodiments, loss function 548 can be configured to minimize the minus mutual information between segmentation result 546a and 546b. Loss function 548 can be further defined by the following equation:

$${L}_{aux} = \frac{- 1}{HW \vert Ω \vert} {\sum }_{i = 1}^{H} {\sum }_{j = 1}^{W} {\sum }_{k , l ∈ Ω} MI ( Φ ( {Z}_{i j} ) , Φ ( {Z}_{k l}^{t} ) ) .$$

In some embodiments, Lₐᵤₓ is the loss function 548 in auxiliary branch 540, H is the height of an image, W is the width of an image, MI is a mutual information function, and Φ is a softmax function. Zᵢⱼ is the segmentation result 546a and Z^{t}ₖₗ is the segmentation result 546b. In some embodiments, pixel locations in the segmentation result 546a are represented by i and j, while pixel locations in segmentation result 546b are represented by k and l. Ω denotes the set that satisfies the neighborhood equation: |i−k|≤μ, |j−l|≤μ, where μ is a hyperparameter that specifies the size of the neighborhood in pixels. A neighborhood defines pixels that are spatially close between an image from set of images 512 and a distorted image from set of distorted images 520.

In some embodiments, G_{f}^{un} describes the number of output nodes in segmentation heads 544a and 544b. Softmax functions Φ(Zᵢⱼ) and Φ(Zₖₗ^{t}) may be interpreted as a possibility distribution over G_{f}^{un} classes. In some aspects, G_{f}^{un} may be the estimated number of fine-grained classes.

In some embodiments, feature extractor 532 in branch 530 and feature extractor 542 in branch 540 share parameters through parameter sharing 560.

In some embodiments, a combined loss function can be defined by weighting loss function 538 and loss function 548 according to: L=(1−λ)Lₘₐᵢₙ+λ Lₐᵤₓ. In one aspect, L is the combined loss function, Lₘₐᵢₙ is the loss function 538 from the main branch 530, Lₐᵤₓ is the loss function 548 from the auxiliary branch 540, and λ is a hyperparameter that represents the tradeoff between loss on branch 530 and branch 540.

In some embodiments, auxiliary branch 540 may be removed after training.

In some embodiments, semantic segmentation by multiple granularity learning has shown enhancement over traditional models. In some embodiments, semantic segmentation models trained using multiple granularity learning (e.g., model training framework 400 and 500) may be tested using both on-road and off-road driving data sets.

In one non limiting example, Cityscapes, a data set which consists of 2,975 images for training and 500 images for validation, may be used to train and validate model training frameworks 400 and 500 for on-road driving. Cityscapes comprises 19 fine-grained classes, which may be grouped into four coarse-grained categories. RELLIS-3D, an off-road driving data set, may be split with 3,302 images for training and 983 images for validation. RELLIS-3D includes 20 fine-grained categories, which may be classified into four coarse-grained categories. In some embodiments, coarse-grained categories may comprise: sky, people, navigable, and non-navigable.

In some embodiments, and in a non-limiting example, semantic segmentation by multiple granularity learning (SSMGL) may be compared to a baseline semantic segmentation model. A baseline model may be trained only using coarse-grained labeled data. Tables I-III below compare segmentation results for a baseline model, a supervised multiple granularity learning model (training framework 400), and an unsupervised multiple granularity model (training framework 500). In some embodiments, a segmentation head comprises DeepLabV3+ and a feature extractor comprises MobileNetV2. Model performance may be reported by adopting the metric mIOU (mean Intersection-over-Union).

TABLE I
COMPARISON TO BASELINES ON CITYSCAPES: DEEPLABV3+
WITH MOBILENETV2. BEST RESULTS ARE IN BOLD.

| Models | mIOU |
|---|---|
| Baseline: coarse-grained training | 89.90 |
| (Ours) SSMGL with unsupervised fine granularity | 90.93 |
| (Ours) SSMGL with supervised fine granularity | 91.71 |

TABLE II
COMPARISON TO BASELINES ON RELLIS-3D: DEEPLABV3+
WITH MOBILENETV2. BEST RESULTS ARE IN BOLD.

| Models | mIOU |
|---|---|
| Baseline: coarse-grained training | 80.24 |
| (Ours) SSMGL with unsupervised fine granularity | 81.27 |
| (Ours) SSMGL with supervised fine granularity | 81.70 |

TABLE III
RESULTS ON CITYSCAPES WITH DIFFERENT BACKBONES AND
SEGMENTATION ARCHITECTURE. BEST RESULTS ARE IN BOLD.

| | |
|---|---|
| Models | mIOU |

DeepLabV3+ with ResNet-50

| | |
|---|---|
| Baseline: coarse-grained training | 91.80 |
| (Ours) SSMGL with unsupervised fine granularity | 92.00 |
| (Ours) SSMGL with supervised fine granularity | 93.01 |

PSPNet with ResNet-50

| | |
|---|---|
| Baseline: coarse-grained training | 89.63 |
| (Ours) SSMGL with unsupervised fine granularity | 90.63 |
| (Ours) SSMGL with supervised fine granularity | 91.05 |

In some embodiments, semantic segmentation through multiple granularity learning trained on the Cityscapes dataset outperforms the baseline by a non-trivial margin: 1.03% mIOU with the unsupervised auxiliary branch, and 1.91% mIOU with the supervised auxiliary branch, respectively. A similar trend is observed in Table II, which shows that semantic segmentation by multiple granularity learning with supervised and unsupervised auxiliary branches improve the segmentation mIOU on an off road driving dataset RELLIS-3D by a margin of 1.03% and 1.54%, respectively.

In some embodiments, semantic segmentation by multiple granularity learning may be evaluated using a different feature extractor and a different segmentation head. Table III shows the results. In some embodiments, a feature extractor may be changed from MobileNetV2 to ResNet-50 (DeepLabV3+ segmentation head). In line with previous results, semantic segmentation through multiple granularity learning still yields mIOU improvements: 0.2 and 1.21 absolute percentage points for the unsupervised and supervised fine granularity, respectively. Furthermore, when the segmentation head is changed from DeepLabV3+ to PSPNet, semantic segmentation by multiple granularity learning consistently outperforms the baseline.

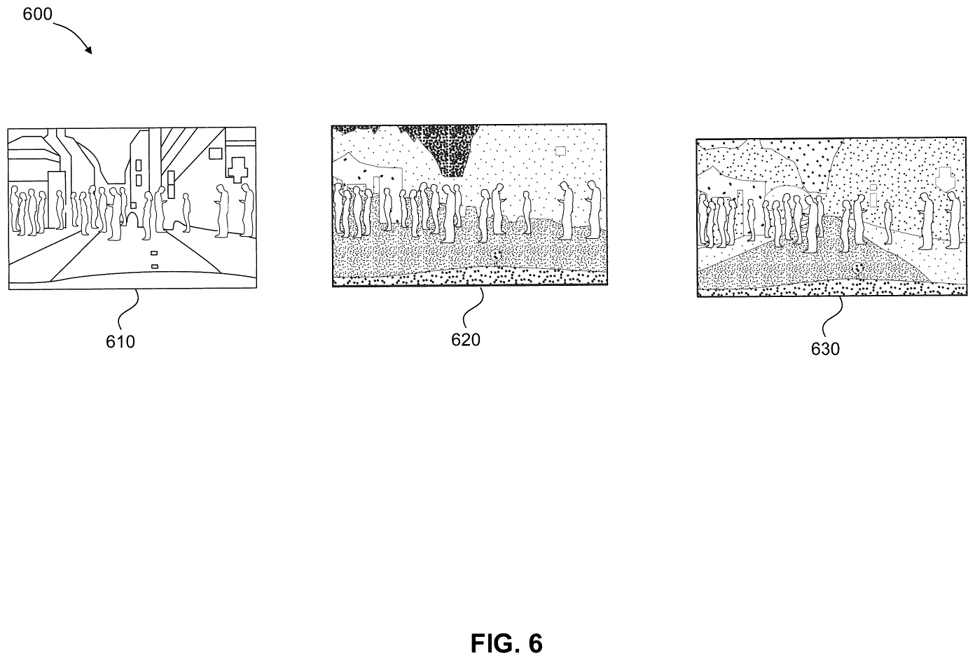

FIG. 6 illustrates an exemplary segmentation result 600, according to some embodiments. FIG. 6 illustrates an input image 610, coarse-grained segmentation result 620, and a fine-grained segmentation result 630. Each patterned region in segmentation result 620 and 630 represents a semantic class.

In some embodiments, coarse grained segmentation result 620 groups the pixels of input image 610 into four classes.

In some embodiments, fine-grained segmentation result 630 groups the pixels of input image 610 into eight classes.

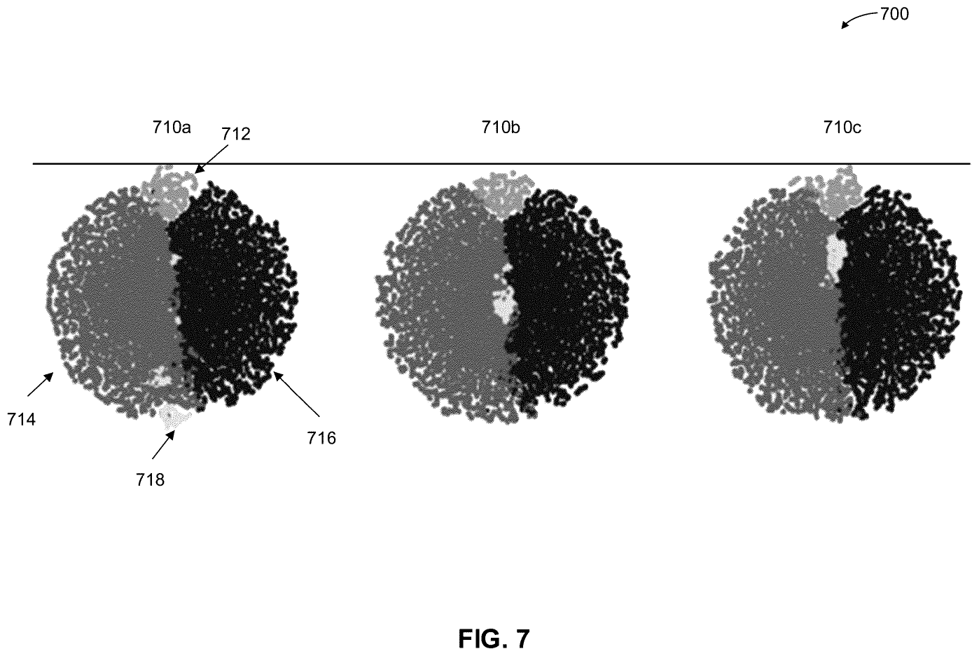

FIG. 7 illustrates a visualization 700, according to some embodiments. For example, visualization 700 can be of an embedding space of semantic classes learned by a baseline model and models trained through multiple granularity learning, according to some embodiments. Visualization of embedding space 700 may comprise a visualization of embedding space for a baseline model 710a, a visualization of an embedding space 710b for a multiple granularity learning model with a self-supervised auxiliary branch (e.g. model training framework 500 in FIG. 5), and a visualization of an embedding space 710c for a multiple granularity learning model with a supervised auxiliary branch (e.g. model training framework 400 in FIG. 4). In one example, different classes learned by the baseline model and multiple granularity model are shown by colors represented by 712, 714, 716, and 718. The different classes learned by the supervised and un-supervised multi-granular models can be more separable than the classes learned by the baseline.

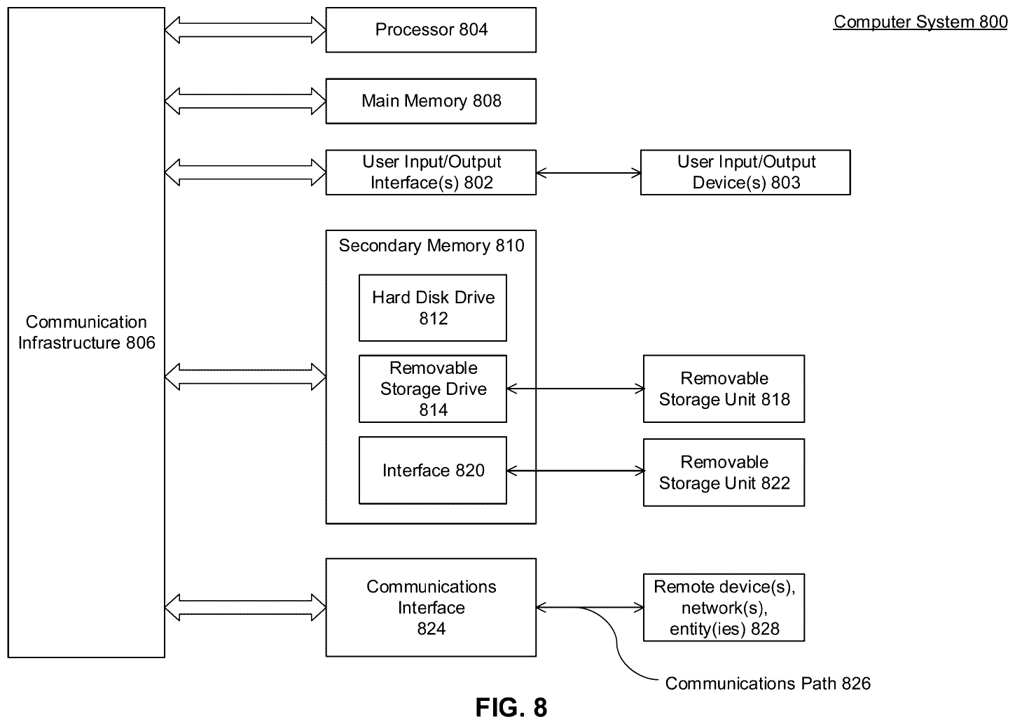

FIG. 8 illustrates an example computer system useful for implementing various embodiments in FIGS. 1-7.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, cameras, other imaging devices etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

Additional embodiments can be found in one or more of the following clauses:

1. A method comprising:
obtaining a set of data comprising a raw image and its corresponding pixel-level semantic labels, wherein the set of data is configured to be used for a coarse-level semantic segmentation model;
preprocessing the set of data to remove invalid or noisy samples;
splitting the set of data into training and validation sets;
designing a framework and corresponding loss functions such that first and second levels of semantic knowledge are leveraged simultaneously to boost first-level semantic segmentation, wherein the first level information is leveraged in the main branch, and the second level information is utilized by adding an auxiliary branch to the main branch;
generating a trained model by minimizing the loss functions on the training set; and
predicting results using the trained model on samples in the validation set,
wherein an auxiliary branch in the trained model is removed for prediction, and
wherein the predicted results are configured to generate the semantic segmentation labels at the pixel-level.

2. The method of clause 1, wherein the framework comprises coarse-level semantic segmentation by multiple-granularity learning (SSMGL) and improving same.

3. The method of clause 1, wherein the set of training and validation data comprises public labeled dataset sources or data captured with an image sensing device followed by manual annotation.

4. The method of clause 3, further comprising using a RGB camera as the imaging sensor.

5. The method of clause 1, wherein the first and second levels comprise coarse level and fine-level semantic knowledge.

6. The method of clause 1, wherein the main branch and the auxiliary branch are trained simultaneously to generate the trained model.

7. The method of clause 1, wherein the predicting is alternatively performed on a data set that comprises samples captured by a user.

8. The method of clause 1, wherein the auxiliary branch can be either supervised or unsupervised.

9. The method of clause 8, wherein the supervised auxiliary branch is adopted for training when the fine-grained labels are also available in the training dataset.

10. The method of clause 8, wherein the unsupervised auxiliary branch is utilized when the fine-grained labels are unavailable.

11. The method of clause 10, wherein unsupervised branch implements representation learning via a self-supervised consistency task.

12. The method of clause 11, wherein the self-supervised consistency task is based on the observations that segmentation should be invariant to mild color distortions and local spatial transitions.

13. The method of clause 12, wherein the consistency is implemented by maximizing the mutual information between representations of raw pixels and representations of mild color distorted and/or spatially distorted pixels.

14. A computer-readable storage medium containing program instructions for a method being executed by an application, the application comprising code for one or more components that are called by the application during runtime, wherein execution of the program instructions by one or more processors of a computer system causes the one or more processors to perform operations comprising:
obtaining a set of data comprising a raw image and its corresponding pixel-level semantic labels, wherein the labels are configured to be used for a coarse-level semantic segmentation model;
preprocessing the set of data to remove invalid or noisy samples;
splitting the set of data into training and validation sets;
designing a framework and corresponding loss functions so that first and second levels of semantic knowledge are leveraged simultaneously to boost first-level semantic segmentation, wherein the first level information is leveraged in the main branch, and the second level information is utilized by adding an auxiliary branch to the main branch;
generating a trained model by minimizing the loss functions on the training set; and
predicting results using the trained model on samples in the validation set,
wherein an auxiliary branch in the trained model is removed for prediction, and
wherein the predicted results are configured to generate the semantic segmentation labels at the pixel-level.

15. The computer implemented method of clause 14, wherein the set of training and validation data is a publicly available labeled data set.

16. The computer implemented method of clause 14, wherein the set of training and validation data is captured with an image sensing device and manually annotated

17. The computer implemented method of clause 16, further comprising an image sensor, an RGB camera for instance.

18. The computer implemented method of clause 14, wherein the first and second levels comprise coarse-grained and fine-grained semantic knowledge.

19. The computer implemented method of clause 14, wherein the main branch and the auxiliary branch are trained simultaneously to generate the trained model.

20. The computer implemented method of clause 16, wherein the prediction is alternatively performed on a data set that comprises samples captured by a user.

21. The computer implemented method of clause 16, wherein the auxiliary branch can be either supervised or unsupervised.

22. The computer implemented method of clause 21, wherein the supervised auxiliary branch is adopted for training when fine-grained labels are also available in the training dataset.

23. The computer implemented method of clause 21, wherein the unsupervised auxiliary branch is utilized when the fine-grained labels are unavailable.

24. The computer implemented method of clause 23, wherein unsupervised branch implements representation learning via a self-supervised consistency task.

25. The computer implemented method of clause 24, wherein the self-supervised consistency task is based on the observations that semantic segmentation should be invariant to mild color distortions and local spatial transitions.

26. The computer implemented method of clause 25, wherein the consistency is implemented by maximizing the mutual information between representations of raw pixels and representations of mild color distorted and/or spatially distorted pixels.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A system comprising:
an image sensor configured to capture image data; and
an image processor configured to:
perform semantic segmentation with a model that is trained using first level and second level semantic information in a multi-granularity framework,
output semantic segmentation results in a user defined format, and
determine an action based on the segmentation results.

2. The system of claim 1, wherein the image processor configured to generate segmentation results for autonomous driving, robotic navigation, and/or to aid in piloting an airborne craft.

3. The system of claim 1, wherein the image processor configured to generate segmentation results on medical images for disease identification and/or surgery.

4. A method comprising:
obtaining, using an image sensor, a set of data comprising raw images and their corresponding pixel-level semantic labels;
preprocessing, using an image processor, the set of data to remove invalid or noisy samples;
splitting, using the image processor, the set of data into a training set and a validation set;
designing, using the image processor, a model and corresponding loss functions such that a first level and a second level of semantic information are leveraged substantially and simultaneously to boost first-level semantic segmentation, the model comprising a main branch and an auxiliary branch, the first level semantic information being utilized in the main branch and the second level semantic information being utilized by the auxiliary branch;
training, using the image processor, the model by utilizing the training set to iteratively minimize the loss functions, wherein model parameters are updated as the loss function is minimized; and
predicting, using the image processor, results using the trained model on samples in the validation set;
wherein the auxiliary branch in the trained model is removed for prediction, and
wherein the predicting results are configured to generate pixel-level semantic segmentation labels.

5. The method of claim 4, wherein the model comprises coarse-level semantic segmentation by multiple-granularity learning (SSMGL).

6. The method of claim 4, wherein the set of training and validation data comprises public labeled dataset sources or data captured with an image sensing device followed by manual annotation.

7. The method of claim 6, further comprising using a camera as the image sensing device.

8. The method of claim 4, wherein the first and second levels of semantic information comprise coarse-level and fine-level semantic information.

9. The method of claim 4, wherein the main branch and the auxiliary branch are trained substantially simultaneously to generate the trained model.

10. The method of claim 4, wherein the predicting is alternatively performed on a data set that comprises samples captured by a user.

11. The method of claim 4, wherein the method is invariant to network architecture.

12. The method of claim 4, wherein the auxiliary branch is supervised or unsupervised.

13. The method of claim 4, wherein a supervised auxiliary branch utilizes fine-grained labels for training.

14. The method of claim 13, wherein the loss function comprises Lₜₒₜₐₗ=(1−λ)Lₘₐᵢₙ+λLₐᵤₓ, wherein Lₘₐᵢₙ is a cross entropy loss in the main branch, Lₐᵤₓ is a focal loss in the auxiliary branch, and λ is a tradeoff between loss in the main branch and loss in the auxiliary branch.

15. The method of claim 4, wherein the auxiliary branch is unsupervised.

16. The method of claim 15, wherein the auxiliary branch implements representation learning via a self-supervised consistency task.

17. The method of claim 16, wherein the self-supervised consistency task is based on the observations that segmentation is invariant to mild color distortions and local spatial transitions.

18. The method of claim 16, wherein:
The self-supervised consistency task is implemented by maximizing mutual information between representations of raw pixels and representations of distorted pixels, and
the distorted pixels are mild color distorted, spatially distorted, or both.

19. The method of claim 15, wherein the loss function comprises Lₜₒₜₐₗ=(1−λ)Lₘₐᵢₙ+λLₐᵤₓ, wherein Lₘₐᵢₙ is a cross entropy loss, Lₐᵤₓ is a minimization of a minus mutual information between an original and distorted image, and lambda is a tradeoff between loss in the main branch and loss in the auxiliary branch.

20. A computer-readable storage medium containing program instructions for a method being executed by an application, the application comprising code for one or more components that are called by the application during runtime, wherein execution of the program instructions by one or more processors of a computer system causes the one or more processors to perform operations comprising:
obtaining a set of data comprising raw images and their corresponding pixel-level semantic labels;
preprocessing the set of data to remove invalid or noisy samples;
splitting the set of data into a training set and a validation set;
designing a model and corresponding loss functions so that a first level and a second level of semantic information are leveraged substantially simultaneously to boost first-level semantic segmentation, the model comprising a main branch and an auxiliary branch, the first level information being leveraged in the main branch, and the second level information being utilized by adding an auxiliary branch to the main branch;
generating a trained model by minimizing the loss functions on the training set; and
predicting results using the trained model on samples in the validation set,
wherein the auxiliary branch in the trained model is removed for prediction, and
wherein the predicting results is configured to generate pixel-level semantic segmentation labels.
